(19) United States
(12) Patent Application Publication
(10) Pub. No.: US 2020/0047285 A1
(43) Pub. Date: Feb. 13, 2020

(54) LASER WELDING OF COATED STEELS ASSISTED BY THE FORMATION OF AT LEAST ONE PRELIMINARY WELD DEPOSIT

(71) Applicant: GM GLOBAL TECHNOLOGY OPERATIONS LLC, Detroit, MI (US)

(72) Inventors: David Yang, Shanghai (CN); Wu Tao, Tianmen (CN)

(21) Appl. No.: 16/097,689

(22) PCT Filed: May 24, 2016
(86) PCT No.: PCT/CN2016/083112

§ 371 Date: Oct. 30, 2018

(51) Int. Cl. B23K 26/244; B23K 26/082; B23K 26/04; B23K 26/22; B23K 26/322

(52) U.S. Cl. CPC B23K 26/244; B23K 26/082; B23K 2103/04; B23K 26/22; B23K 26/322; B23K 26/048

(57) ABSTRACT

A method of laser welding a workpiece stack-up (10) that includes at least two overlapping steel workpieces, at least one of which includes a surface coating of a zinc-based material. The method includes forming at least one preliminary weld deposit (74) in the workpiece stack-up (10) and, thereafter, forming a principal laser weld joint. The formation of the principal laser spot weld joint involves advancing a principal welding laser beam (90) relative to a plane of the top surface (20) of the workpiece stack-up (10) along a beam travel pattern (104) that lies within an annular weld area (92). The beam travel pattern (104) of the principal welding laser beam (90) surrounds a center area (98) on the plane of the top surface (20) that spans the at least one preliminary weld deposit (74) formed in the workpiece stack-up (10).

### TECHNICAL FIELD

The technical field of this disclosure relates generally to laser welding and, more particularly, to a method of laser welding together two or more overlapping steel workpieces in which at least one of the steel workpieces includes a zinc-based surface coating.

### BACKGROUND

Laser welding is a metal joining process in which a laser beam is directed at a metal workpiece stack-up to provide a concentrated energy source capable of effectuating a weld joint between the overlapping constituent metal workpieces. In general, two or more metal workpieces are first aligned and stacked relative to one another such that their faying surfaces overlap and confront to establish a faying interface (or faying interfaces) that extends through an intended weld site. A laser beam is then directed towards and impinges a top surface of the workpiece stack-up. The heat generated from the absorption of energy from the laser beam initiates melting of the metal workpieces and creates a molten weld pool within the workpiece stack-up. And, if the power density of the laser beam is high enough, a keyhole is produced directly underneath the laser beam and is surrounded by the molten weld pool. A keyhole is a column of vaporized metal derived from the metal workpieces within the workpiece stack-up that may include plasma.

The laser beam creates the molten weld pool in very short order upon impinging the top surface of the workpiece stack-up. Once created, the molten weld pool grows as the laser beam continues to deliver energy to the workpiece stack-up. The molten weld pool eventually grows to penetrate through the metal workpiece impinged by the laser beam and into the underlying metal workpiece or workpieces to a depth that intersects each of the established faying interfaces. The general shape and penetration depth of the molten weld pool can be managed by controlling various characteristics of the laser beam including its power, travel velocity (if any), and focal position. When the molten weld pool has reached the desired penetration depth in the workpiece stack-up, and optionally been moved within the stack-up by advancing the laser beam along the top surface of the stack-up, the transmission of the laser beam is ceased so that it no longer impinges the stack-up at the weld site. The molten weld pool quickly cools and solidifies (and collapses the keyhole if present) to form a laser weld joint comprised of resolidified composite workpiece material derived from each of the workpieces penetrated by molten weld pool. The resolidified composite workpiece material of the laser weld joint autogenously fusion welds the overlapping workpieces together at the weld site.

The automotive industry is interested in using laser welding to manufacture parts that can be installed on a vehicle. In one example, a vehicle door body may be fabricated from an inner door panel and an outer door panel that are joined together by a plurality of laser weld joints. The inner and outer door panels are first stacked relative to each other and secured in place by clamps. A laser beam is then sequentially directed at multiple weld sites around the stacked panels in accordance with a programmed sequence to form the plurality of laser weld joints as previously described. The process of laser welding inner and outer door panels—as well as other vehicle part components such as those used to fabricate hoods, deck lids, body structures such as body sides and cross-members, load-bearing structural members, engine compartments, etc.—is typically an automated process that can be carried out quickly and efficiently. The aforementioned desire to laser weld metal workpieces together is not unique to the automotive industry; indeed, it extends to other industries that may utilize laser welding including the aviation, maritime, railway, and building construction industries, among others.

The use of laser welding to join together coated metal workpieces that are often used in manufacturing practices can present challenges. For example, steel workpieces often include a zinc-based surface coating for corrosion protection. Zinc has a boiling point of about 906° C., while the melting point of the base steel substrate it coats is typically greater than 1300° C. Thus, when a steel workpiece that includes a zinc-based surface coating is laser welded, high-pressure zinc vapors are readily produced at the surfaces of the steel workpiece and have a tendency to disrupt the laser welding process. In particular, the zinc vapors produced at the faying interface(s) of the steel workpieces are forced to diffuse into and through the molten weld pool created by the laser beam unless an alternative escape outlet is provided through the workpiece stack-up. When an adequate escape outlet is not provided, zinc vapors may remain trapped in the molten weld pool as it cools and solidifies, which may lead to defects in the resulting weld joint—such as entrained porosity—as well as other weld joint discrepancies such as spatter, blowholes, and undercut joints. These weld joint deficiencies, if sever enough, can unsatisfactorily degrade the mechanical properties of the laser weld joint.

To deter high-pressure zinc vapors from diffusing into the molten weld pool, conventional manufacturing procedures have called for laser scoring or mechanical dimpling at least one of the two steel workpieces at each faying interface where a zinc-based coating is present before laser welding is conducted. The laser scoring or mechanical dimpling processes create spaced apart protruding features that impose a gap of about 0.1-0.2 millimeters between the faying surface on which they have been formed and the confronting faying surface of the adjacent steel workpiece, which provides an escape path to guide zinc vapors along the established faying interface and away from the weld site. But the formation of these protruding features adds an additional step to the overall laser welding process and is believed to contribute to the occurrence of undercut weld joints. It would be a welcome addition to the art if two or more steel workpieces—at least one of which includes a surface coating of a zinc-based material—could be laser welded together without having to necessarily score or mechanically dimple any of the steel workpieces in order to consistently form a durable weld joint with sufficient strength.

### SUMMARY OF THE DISCLOSURE

A method of laser welding a workpiece stack-up that includes overlapping steel workpieces is disclosed. The workpiece stack-up includes two or more steel workpieces, and at least one of those steel workpieces (and possibly all of the steel workpieces) includes a surface coating of a zinc-based material such as zinc or a zinc-iron alloy. The zinc-based surface coating preferably has a thickness that ranges from 2 μm to 50 μm. And while a zinc-based surface coating protects the underlying steel from corrosion, among other notable benefits, it can evolve high pressure zinc vapors when heated during laser welding. The evolution of such zinc vapors, in turn, can be a source of porosity in the laser weld joint and can also lead to other abnormalities such as spatter and blowholes. The disclosed laser welding method minimizes the impact that zinc-based surface coatings may have on the laser weld joint without requiring—but of course not prohibiting—the practice of certain procedures such as, for example, the intentional imposition of gaps between the steel workpieces at the faying interface where the zinc-based surface coating is present by way of laser scoring or mechanical dimpling.

To begin, the laser welding method involves providing a workpiece stack-up that includes two or more overlapping steel workpieces. The steel workpieces are stacked together such that a faying interface is formed between the faying surfaces of each pair of adjacent overlapping steel workpieces at a weld site. For example, in one embodiment, the workpiece stack-up includes first and second steel workpieces having first and second faying surfaces, respectively, that overlap and confront one another to establish a single faying interface. In another embodiment, the workpiece stack-up includes an additional third steel workpiece situated between the first and second steel workpieces. In this way, the first and second steel workpieces have first and second faying surfaces, respectively, that overlap and confront opposed faying surfaces of the third steel workpiece to establish two faying interfaces. When a third steel workpiece is present, the first and second steel workpieces may be separate and distinct parts or, alternatively, they may be different portions of the same part, such as when an edge of one part is folded over a free edge of another part.

After the workpiece stack-up is provided, a preliminary welding laser beam is directed at, and impinges, a top surface of the workpiece stack-up at an initial spot location to create a preliminary molten steel weld pool that penetrates into the workpiece stack-up from the top surface towards the bottom surface. The power density of the preliminary welding laser beam is selected to carry out this particular portion of the disclosed laser welding method in either conduction welding mode or keyhole welding mode. In conduction welding mode, the power density of the preliminary welding laser beam is relatively low, and the energy of the preliminary welding laser beam is conducted as heat through the steel workpieces to create only the preliminary molten steel weld pool. In keyhole welding mode, on the other hand, the power density of the preliminary welding laser beam is high enough to vaporize the steel workpieces and produce a keyhole directly underneath the preliminary welding laser beam within the preliminary molten steel weld pool. The keyhole provides a conduit for energy absorption deeper into workpiece stack-up which, in turn, facilitates deeper and narrower penetration of the preliminary molten steel weld pool.

The preliminary welding laser beam may be fixedly trained at the initial spot location on the top surface or it may be moved relative to a plane of the top surface at the initial spot location until the preliminary molten steel weld pool grows to the desired size. The preliminary molten steel weld pool may partially or fully penetrate the workpiece stack-up. In a preferred embodiment, for example, the preliminary molten steel weld pool is grown so that it intersects each faying interface (single interface in a two-workpiece stack-up or both interfaces in a three-workpiece stack-up) established within the workpiece stack-up, meaning that the preliminary molten steel weld pool fully traverses a thickness of the first steel workpiece and at least partially traverses a thickness of the second steel workpiece. Once the preliminary molten steel weld pool has reached the desired size, in terms of depth and diameter, the transmission of the preliminary welding laser beam is ceased at the initial spot weld location, causing the preliminary molten steel weld pool to solidify into a preliminary weld deposit. The preliminary weld deposit either partially or fully penetrates the workpiece stack-up depending on the acquired depth of the preliminary molten steel weld pool. Additional preliminary weld deposits may be formed at other initial spot locations in the same way. Anywhere from one to eight preliminary weld deposits are preferably formed depending on the size of the weld deposit(s) as well as the compositions of the steel workpieces.

Following the formation of the preliminary weld deposit(s), a principal welding laser beam is directed at, and impinges, the top surface of the workpiece stack-up radially outside of and away from the initial spot location(s) where the preliminary weld deposit(s) have been formed to create a principal molten steel weld pool that penetrates into the workpiece stack-up from the top surface towards the bottom surface and intersects each faying interface established within the stack-up. The power density of the principal welding laser beam, like before, is selected to carry out this particular portion of the disclosed laser welding method in either conduction welding mode or keyhole welding mode. The designation of the laser beams as “principal” and “preliminary” is not necessarily intended to indicate a difference in laser beam type, although such distinctions are not foreclosed, but rather is meant to specify the sequence in which the laser beams act on the workpiece stack-up and to differentiate where on the top surface of the stack-up the laser beams are directed. In particular, the preliminary welding laser beam is used to form the preliminary weld deposit(s) first, and, afterwards, the principal welding laser beam is advanced relative to the plane of the top surface of the workpiece stack-up around the preliminary weld deposit(s) to form a principal laser weld joint. The preliminary weld deposit(s) are formed basically to promote the strength and integrity of the principal laser weld joint, which is the primary structural joint that fusion joints the steel workpieces together.

The principal welding laser beam is advanced relative to the plane of the top surface of the workpiece stack-up along a beam travel pattern following creation of the principal molten steel weld pool and, optionally, the keyhole. Advancing the principal welding laser beam along the beam travel pattern translates the keyhole and the principal molten steel weld pool along a route that corresponds to the patterned movement of the principal welding laser beam relative to the top surface of the workpiece stack-up. Such advancement of the principal welding laser beam along the beam travel pattern leaves behind a trail of molten steel workpiece material in the wake of the principal welding laser beam and the corresponding route of the principal molten steel weld pool. This trail of molten steel workpiece material quickly cools and solidifies into resolidified composite steel workpiece material that is comprised of steel material from each steel workpiece penetrated by the principal molten steel weld pool. After the principal welding laser beam has completed its advancement along the beam travel pattern, the transmission of the principal welding laser beam within the annular weld area is ceased to terminate energy transfer to the workpiece stack-up. The collective resolidified composite steel workpiece material obtained from advancing the principal welding laser beam along the beam travel pattern provides the principal laser weld joint that autogenously fusion welds the workpieces together.

The beam travel pattern traced by the principal welding laser beam includes one or more weld paths that lie within an annular weld area as projected onto the plane (the x-y plane) of the top surface of the workpiece stack-up. The annular weld area that delimits the beam travel pattern surrounds a center area on the plane of the top surface that spans the at least one preliminary weld deposit. Consequently, as the principal welding laser beam moves along the beam travel pattern within the annular weld area, it does so without impinging on the center area. This type of patterned movement of the principal welding laser beam induces changes to the fluid velocity field within the principal molten steel weld pool, which agitates the weld pool and disturbs entrained zinc vapors, thereby promoting zinc vapor evolution from the weld pool. Additionally, the formation of the preliminary weld deposit(s) can reduce the amount of vaporizable zinc within the regions of the workpiece stack-up beneath the center area and annular weld area by boiling zinc and/or converting zinc to zinc oxide. As such, the composite resolidified steel workpiece material that constitutes the principal laser weld joint is less liable to include a debilitating amount of entrained porosity or be accompanied by other laser welding discrepencies such as spatter and/or blowholes.

In a preferred embodiment, a remote laser welding apparatus is used to form both the at least one preliminary weld deposit and the principal laser weld joint in the workpiece stack-up. The remote laser welding apparatus includes a scanning optic laser head that houses optical components that can move a laser beam relative to the plane at the top surface of the workpiece stack-up and also adjust a focal point of the laser beam up or down along a longitudinal axis of the laser beam. Separately-transmitted laser beams can thus be transmitted from the scanning optic laser head to form, in sequence, the at least one preliminary weld deposit and the principal laser weld joint. In particular, within a predetermined weld site, the scanning optic laser head directs the preliminary welding laser beam at a spot location on the top surface of the workpiece stack-up to form the preliminary weld deposit, and can optionally do so multiple times to form additional preliminary laser deposits, if desired. Then, after formation of the preliminary weld deposit(s), the same scanning optic laser head directs the principal welding laser beam at the top surface of the workpiece stack-up within the annular weld area and advances the laser beam along the beam travel pattern to form the principal laser weld joint.

### BRIEF DESCRIPTION OF THE DRAWINGS

FIG. 1 is a perspective view of an embodiment of a remote laser welding apparatus for forming at least one preliminary weld deposit in a workpiece stack-up that includes overlapping steel workpieces followed by forming a principal laser weld joint in the same stack-up;

FIG. 1A is a magnified view of a general laser beam depicted in FIG. 1 showing a focal point and a longitudinal beam axis of the general laser beam;

FIG. 2 is a plan view of a top surface of the workpiece stack-up illustrating the use of a preliminary welding laser beam to form the at least one preliminary weld deposit and, subsequently, the use of a principal welding laser beam to form the principal laser weld joint, and wherein each of the preliminary welding laser beam and the principal welding laser beam are transmitted to the top surface of the workpiece stack-up by the scanning optic laser head of the remote laser welding apparatus;

FIG. 3 is a cross-sectional view (taken along line 3-3) of the workpiece stack-up depicted in FIG. 2 showing a preliminary molten steel weld pool and a keyhole, which are created by a preliminary welding laser beam, that penetrate into the workpiece stack-up from the top surface towards the bottom surface;

FIG. 4 is a cross-sectional view of the workpiece stack-up taken from the same perspective as FIG. 3 and showing a preliminary weld deposit that formed after the transmission of the preliminary welding laser beam has ceased and the preliminary molten steel weld pool has solidified;

FIG. 5 is a cross-sectional view (taken along line 5-5) of the workpiece stack-up depicted in FIG. 2 showing a principal molten steel weld pool and a keyhole, which are produced by a principal welding laser beam subsequent to the formation of the at least one preliminary weld deposit, that penetrate into the workpiece stack-up from the top surface towards the bottom surface and intersect each faying interface established within the stack-up;

FIG. 6 depicts an embodiment of the beam travel pattern as projected onto the top surface of the workpiece stack-up that may be traced by the principal welding laser beam, and thus followed by the keyhole and the surrounding principal molten steel weld pool, during formation of a principal laser weld joint between the overlapping steel workpieces included in the workpiece stack-up;

FIG. 7 depicts another embodiment of the beam travel pattern as projected onto the top surface of the workpiece stack-up that may be traced by the principal welding laser beam, and thus followed by the keyhole and the surrounding principal molten steel weld pool, during formation of a principal laser weld joint between the overlapping steel workpieces included in the workpiece stack-up;

FIG. 8 depicts yet another embodiment of a beam travel pattern as projected onto the top surface the workpiece stack-up that is similar to the beam travel pattern shown in FIG. 7;

FIG. 9 depicts still another embodiment of the beam travel pattern as projected onto the top surface of the workpiece stack-up that may be traced by the principal welding laser beam, and thus followed by a keyhole and the surrounding principal molten steel weld pool, during formation of a principal laser weld joint between the overlapping steel workpieces included in the workpiece stack-up;

FIG. 10 is a cross-sectional view of the workpiece stack-up taken from the same perspective as FIG. 3 and showing a preliminary molten steel weld pool and a keyhole, which are created by a preliminary welding laser beam, that penetrate into the workpiece stack-up from the top surface towards the bottom surface, although here the workpiece stack-up includes three steel workpieces that establish two faying interfaces, as opposed to two steel workpieces that establish a single faying interface as depicted in FIG. 3;

FIG. 11 is a cross-sectional view of the workpiece stack-up taken from the same perspective as FIG. 4 and showing a preliminary weld deposit that formed after the transmission of the preliminary welding laser beam has ceased and the preliminary molten steel weld pool has solidified, although here the workpiece stack-up includes three steel workpieces that establish two faying interfaces, as opposed to two steel workpieces that establish a single faying interface as depicted in FIG. 4; and

FIG. 12 is a cross-sectional view taken from the same perspective as FIG. 5 and showing a principal molten steel weld pool and a keyhole, which are produced by a principal welding laser beam subsequent to the formation of the at least one preliminary weld deposit, that penetrate into the workpiece stack-up from the top surface towards the bottom surface and intersect each faying interface established within the stack-up, although here the workpiece stack-up includes three steel workpieces that establish two faying interfaces, as opposed to two steel workpieces that establish a single faying interface as depicted in FIG. 5.

### DETAILED DESCRIPTION

The disclosed method of laser welding a workpiece stack-up comprised of two or more overlapping steel workpieces involves, first, forming at least one preliminary weld deposit in the workpiece stack-up with a preliminary welding laser beam and, second, forming a principal laser weld joint by impinging a top surface of the workpiece stack-up with a principal welding laser beam and advancing the principal welding laser beam relative to a plane of the top surface along a beam travel pattern confined within an annular weld area. The annular weld area and, thus, the beam travel pattern, surrounds a center area that spans the at least one preliminary weld deposit previously formed in the workpiece stack-up. The number of preliminary weld deposits spanned by the center area, which is not impinged by the principal welding laser beam during its advancement along the beam travel pattern, may range from a single preliminary weld deposit to a plurality of preliminary weld deposits, with a typical number of preliminary weld deposits ranging anywhere from one to eight. Each of the preliminary weld deposits may intersect each of the faying interfaces established within the workpiece stack-up.

The principal laser weld joint, which is the primary joint that fusion welds the overlapping steel workpieces together at a weld site, is less liable to include entrained porosity or be accompanied by spatter or blowholes for at least two reasons: (1) the patterned movement of the principal welding laser beam promotes more aggressive zinc vapor evolution from the corresponding principal molten steel weld pool; and (2) the preceding formation of the at least one preliminary weld deposit acts to remove vaporizable zinc from the workpiece stack-up in the regions beneath the center area and the annular weld area. Moreover, if any porosity is present in the resolidified composite steel workpiece material of the principal laser weld joint, the conductive heat transfer that emanates radially inward from the annular weld area during laser welding has the affect of sweeping porosity into a region of the principal laser weld joint beneath the center area defined on the plane of the top surface of the workpiece stack-up. This is noteworthy since centrally located porosity is less likely to affect the mechanical properties of the principal laser weld joint compared to porosity located at the perimeter of the joint.

The at least one preliminary weld deposit and the principal laser weld joint can be formed using the same laser welding apparatus. For example, a remote laser welding apparatus or a conventional laser welding apparatus may be operated to form the at least one preliminary weld deposit and the principal laser weld joint in succession using the preliminary welding laser beam and the principal welding laser beam, respectively, that may or may not differ in their beam characteristics (e.g., power level, focal point location, travel speed, etc.). Each of the preliminary welding laser beam and the principal welding laser beam may be a solid-state laser beam or a gas laser beam depending on the characteristics of the steel workpieces being joined and the laser welding apparatus being used. Some notable solid-state lasers that may be used are a fiber laser, a disk laser, a direct diode laser, and a Nd:YAG laser, and a notable gas laser that may be used is a CO₂ laser, although other types of lasers may certainly be employed. In a preferred implementation of the disclosed method, which is described below in more detail, a remote laser welding apparatus is operated to sequentially form both the at least one preliminary weld deposit and the principal laser weld joint through the use of a solid-state state laser that can serve as both the preliminary welding laser beam and the principal welding laser beam.

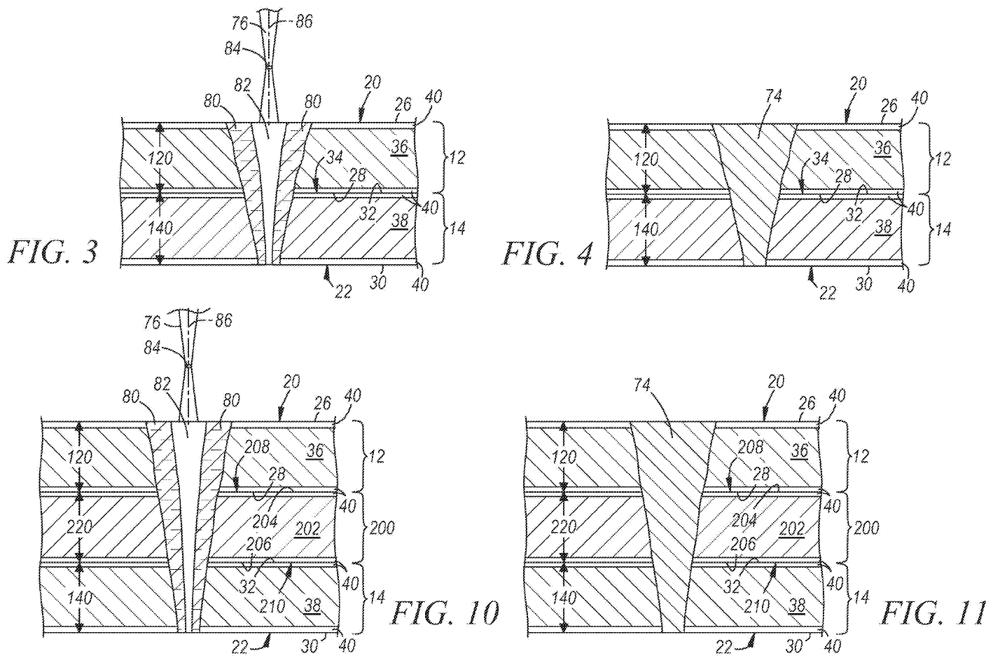

The disclosed laser welding method may be performed on a variety of workpiece stack-up configurations. For example, the disclosed method may be used in conjunction with a “2T” workpiece stack-up (FIGS. 3-5) that includes two overlapping and adjacent steel workpieces, or it may be used in conjunction with a “3T” workpiece stack-up (FIGS. 10-12) that includes three overlapping and adjacent steel workpieces. Still further, in some instances, the disclosed method may be used in conjunction with a “4T” workpiece stack-up (not shown) that includes four overlapping and adjacent steel workpieces. Additionally, the several steel workpieces included in the workpiece stack-up may have similar or dissimilar strengths and grades, and may have similar or dissimilar thicknesses at the weld site, if desired. The disclosed laser welding method is carried out in essentially the same way to achieve the same results regardless of whether the workpiece stack-up includes two overlapping steel workpieces or more than two overlapping steel workpieces. Any differences in workpiece stack-up configurations can be easily accommodated by adjusting the characteristics of the preliminary welding laser beam and the principal welding laser beam to achieve the same end result.

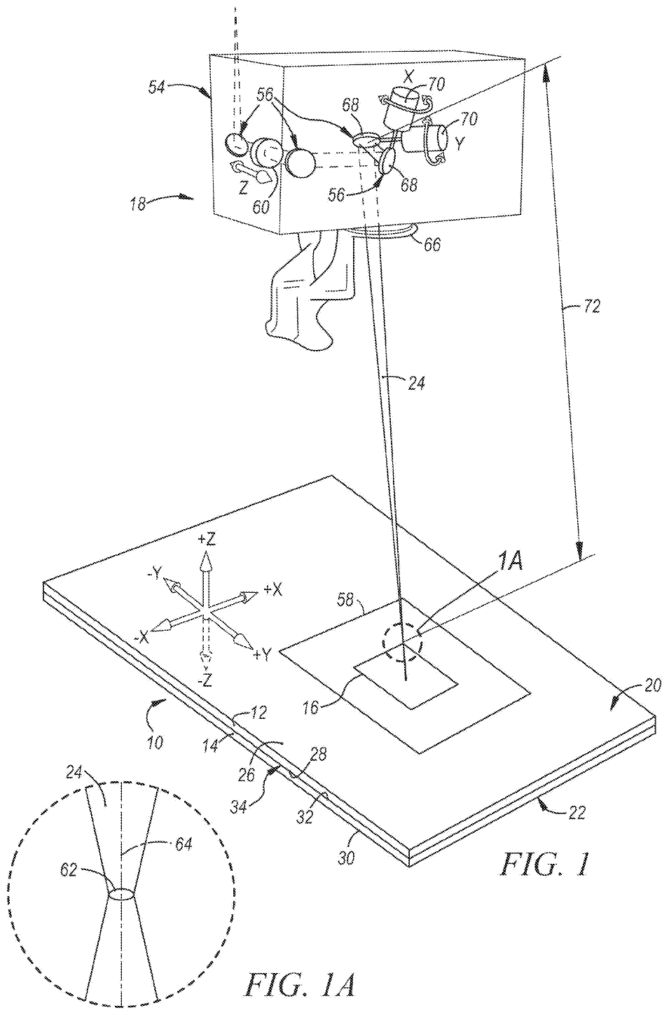

Referring now to FIGS. 1-9, a method of laser welding a workpiece stack-up 10 is shown in which the stack-up 10 includes a first steel workpiece 12 and a second steel workpiece 14 that overlap at a weld site 16 where laser welding is conducted using a remote laser welding apparatus 18. The first and second steel workpieces 12, 14 provide a top surface 20 and a bottom surface 22, respectively, of the workpiece stack-up 10. The top surface 20 of the workpiece stack-up 10 is made available to the remote laser welding apparatus 18 and is accessible by a laser beam 24 emanating from the remote laser welding apparatus 18. And since only single side access is needed to conduct laser welding, there is no need for the bottom surface 22 of the workpiece stack-up 10 to be made available to the remote laser welding apparatus 18 in the same way as the top surface 20. Moreover, while only one weld site 16 is depicted in the Figures for the sake of simplicity, skilled artisans will appreciate that laser welding in accordance with the disclosed laser welding method can be practiced at multiple different weld sites spread throughout the same workpiece stack-up.

The workpiece stack-up 10 may include only the first and second steel workpieces 12, 14, as shown in FIGS. 1 and 3-5. Under these circumstances, and as shown best in FIGS. 3-5, the first steel workpiece 12 includes an exterior outer surface 26 and a first faying surface 28, and the second steel workpiece 14 includes an exterior outer surface 30 and a second faying surface 32. The exterior outer surface 26 of the first steel workpiece 12 provides the top surface 20 of the workpiece stack-up 10 and the exterior outer surface 30 of the second steel workpiece 14 provides the oppositely-facing bottom surface 22 of the stack-up 10. And, since the two steel workpieces 12, 14 are the only workpieces present in the workpiece stack-up 10, the first and second faying surfaces 28, 32 of the first and second steel workpieces 12, 14 overlap and confront to establish a faying interface 34 that extends through the weld site 16. In other embodiments, one of which is described below in connection with FIGS. 10-12, the workpiece stack-up 10 may include an additional steel workpiece disposed between the first and second steel workpieces 12, 14 to provide the stack-up 10 with three steel workpieces instead of two.

The term “faying interface” is used broadly in the present disclosure and is intended to encompass a wide range of overlapping relationships between the confronting first and second faying surfaces 28, 32 that can accommodate the practice of laser welding. For instance, the faying surfaces 28, 32 may establish the faying interface 34 by being in direct or indirect contact. The faying surfaces 28, 32 are in direct contact with each other when they physically abut and are not separated by a discrete intervening material layer or gaps that fall outside of normal assembly tolerance ranges. The faying surfaces 28, 32 are in indirect contact when they are separated by a discrete intervening material layer such as a structural adhesive—and thus do not experience the type of interfacial abutment that typifies direct contact—yet are in close enough proximity that laser welding can be practiced. As another example, the faying surfaces 28, 32 may establish the faying interface 34 by being separated by gaps that are purposefully imposed. Such gaps may be imposed between the faying surfaces 28, 32 by creating protruding features on one or both of the faying surfaces 28, 32 through laser scoring, mechanical dimpling, or otherwise. The protruding features maintain intermittent contact points between the faying surfaces 28, 32 that keep the faying surfaces 28, 32 spaced apart outside of and around the contact points by up to 1.0 mm and, preferably, between 0.2 mm and 0.8 mm.

As shown in FIG. 3, the first steel workpiece 12 includes a first base steel substrate 36 and the second steel workpiece 14 includes a second base steel substrate 38. Each of the base steel substrates 36, 38 may be separately composed of any of a wide variety of steels including a low carbon steel (also commonly referred to as mild steel), interstitial-free (IF) steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece 12, 14 includes press-hardened steel (PHS). Moreover, each of the first and second base steel substrates 36, 38 may be treated to obtain a particular set of mechanical properties, including being subjected to heat-treatment processes such as annealing, quenching, and/or tempering. The first and second steel workpieces 12, 14 may be hot or cold rolled and may be pre-fabricated to have a particular profile suitable for assembly into the workpiece stack-up 10.

At least one of the first or second steel workpieces 12, 14—and sometimes both includes a surface coating 40 that overlies the base steel substrate 36, 38. Still referring to FIG. 3, each of the first and second base steel substrates 36, 38 is coated with a surface coating 40 that, in turn, provides the steel workpieces 12, 14 with their respective exterior outer surfaces 26, 30 and their respective faying surfaces 28, 32. The surface coating 40 applied to one or both of the base steel substrates 36, 38 is a zinc-based material. Some examples of a zinc-based material include zinc or a zinc-iron alloy that preferably has a bulk average composition that includes 8 wt % to 12 wt % iron and 0.5 wt % to 4 wt % aluminum with the balance (in wt %) being zinc. A coating of a zinc-based material may be applied by hot-dip galvanizing (zinc coating), electro-galvanizing (zinc coating), or galvannealing (zinc-iron alloy coating), typically to a thickness of between 2 μm and 50 μm, although other coating procedures and thicknesses of the attained coatings may be employed. Taking into the account the thickness of the base steel substrates 36, 38 and their optional surface coatings 40, each of the first and second steel workpieces 12, 14 has a thickness 120, 140 that preferably ranges from 0.4 mm to 4.0 mm, and more narrowly from 0.5 mm to 2.0 mm, at least at the weld site 16. The thicknesses 120, 140 of the first and second steel workpieces 12, 14 may be the same of different from each other.

Referring back to FIG. 1, the remote laser welding apparatus 18 includes a scanning optic laser head 54. The scanning optic laser head 54 directs the laser beam 24 at the top surface 20 of the workpiece stack-up 10 which, here, is provided by the exterior outer surface 26 of the first steel workpiece 12. The scanning optic laser head 54 is preferably mounted to a robotic arm (not shown) that can quickly and accurately carry the laser head 54 to many different preselected weld sites 16 on the workpiece stack-up 10 in rapid programmed succession. The laser beam 24 used in conjunction with the scanning optic laser head 54 is preferably a solid-state laser beam operating with a wavelength in the near-infrared range (commonly considered to be 700 nm to 1400 nm) of the electromagnetic spectrum. Additionally, the laser beam 24 has a power level capability that can attain a power density sufficient to melt the steel workpieces 12, 14 in the workpiece stack-up 10 and, if desired, to produce a keyhole. The power density needed to produce a keyhole within overlapping steel workpieces is typically in the range of 0.5-1.0 MW/cm².

Some examples of a suitable solid-state laser beam that may be used in conjunction with the remote laser welding apparatus 18 include a fiber laser beam, a disk laser beam, and a direct diode laser beam. A preferred fiber laser beam is a diode-pumped laser beam in which the laser gain medium is an optical fiber doped with a rare earth element (e.g., erbium, ytterbium, neodymium, dysprosium, praseodymium, thulium, etc.). A preferred disk laser beam is a diode-pumped laser beam in which the gain medium is a thin laser crystal disk doped with a rare earth element (e.g., a ytterbium-doped yttrium-aluminum garnet (Yb:YAG) crystal coated with a reflective surface) and mounted to a heat sink. And a preferred direct diode laser beam is a combined laser beam (e.g., wavelength combined) derived from multiple diodes in which the gain medium is semiconductors such as those based on aluminum gallium arsenide (AlGaAS) or indium gallium arsenide (InGaAS). Other solid-state laser beams not specifically mentioned here may of course be used.

The scanning optic laser head 54 includes an arrangement of mirrors 56 that can maneuver the laser beam 24 relative to a plane oriented along the top surface 20 of the workpiece stack-up 10 within an operating envelope 58 that encompasses the weld site 16. Here, as illustrated in FIG. 1, the plane of the top surface 20 encompassed by the operating envelope 58 is labeled the x-y plane since the position of the laser beam 24 within the plane is identified by the “x” and “y” coordinates of a three-dimensional coordinate system. In addition to the arrangement of mirrors 56, the scanning optic laser head 54 also includes a z-axis focal lens 60, which can move a focal point 62 (FIG. 1A) of the laser beam 24 along a longitudinal axis 64 of the laser beam 24 to thus vary the location of the focal point 62 in a z-direction that is oriented perpendicular to the x-y plane in the three-dimensional coordinate system established in FIG. 1. Furthermore, to keep dirt and debris from adversely affecting the optical system components and the integrity of the laser beam 24, a cover slide 66 may be situated below the scanning optic laser head 54. The cover slide 66 protects the arrangement of mirrors 56 and the z-axis focal lens 60 from the surrounding environment yet allows the laser beam 24 to pass out of the scanning optic laser head 54 without substantial disruption.

The arrangement of mirrors 56 and the z-axis focal lens 60 cooperate during operation of the remote laser welding apparatus 18 to dictate the desired movement of the laser beam 24 within the operating envelope 58 at the weld site 16 as well as the position of the focal point 62 along the longitudinal axis 64 of the beam 24. The arrangement of mirrors 56 includes a pair of tiltable scanning mirrors 68. Each of the tiltable scanning mirrors 68 is mounted on a galvanometer 70. The two tiltable scanning mirrors 68 can move the location at which the laser beam 24 impinges the top surface 20 of the workpiece stack-up 10 anywhere in the x-y plane of the operating envelope 58 through precise coordinated tilting movements executed by the galvanometers 70. At the same time, the z-axis focal lens 60 controls the location of the focal point 62 of the laser beam 24 in order to help administer the laser beam 24 at the correct power density. All of these optical components 60, 68 can be rapidly indexed in a matter of milliseconds or less to advance the laser beam 24 relative to the top surface 20 of the workpiece stack-up 10 at a travel velocity that may reach as high as 120 m/min (meters per minute) while positioning the focal point 62 of the laser beam somewhere between 100 mm above (+100 mm) the top surface 20 of the workpiece stack-up 10 and 100 mm below (−100 mm) the top surface 20 along the longitudinal beam axis 64.

A characteristic that differentiates remote laser welding (also sometimes referred to as “welding on the fly”) from other conventional forms of laser welding is the focal length of the laser beam 24. Here, as shown in best in FIG. 1, the laser beam 24 has a focal length 72, which is measured as the distance between the focal point 62 and the last tiltable scanning mirror 68 that intercepts and reflects the laser beam 24 prior to the laser beam 24 impinging the top surface 20 of the workpiece stack-up 10 (also the exterior outer surface 26 of the first steel workpiece 12). The focal length 72 of the laser beam 24 is preferably in the range of 0.4 meters to 2.0 meters with a diameter of the focal point 62 typically ranging anywhere from 350 μm to 700 μm. The scanning optic laser head 54 shown generally in FIG. 1 and described above, as well as others that may be constructed somewhat differently, are commercially available from a variety of sources. Some notable suppliers of scanning optic laser heads and lasers for use with the remote laser welding apparatus 18 include HIGHYAG (Kleinmachnow, Germany) and TRUMPF Inc. (Farmington, Conn., USA).

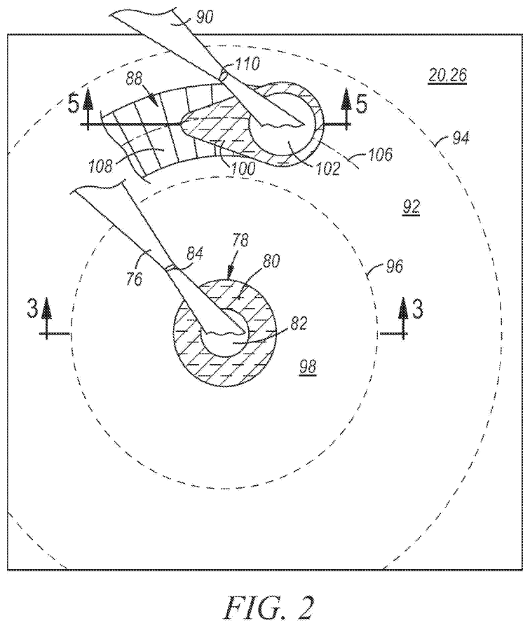

As part of the disclosed laser welding method, and referring now to FIGS. 1-4, at least one preliminary weld deposit 74 (FIG. 4) is formed in the workpiece stack-up 10. The at least one preliminary weld deposit 74 is preferably formed by operation of the remote laser welding apparatus 18. As illustrated best in FIGS. 2-3, the laser beam 24 transmitted from the scanning optic laser head 54 of the remote laser welding apparatus 18 is operated as a preliminary welding laser beam 76. The preliminary welding laser beam 76 is directed at, and impinges, the top surface 20 of the workpiece stack-up 10 at a spot location 78 within the weld site 16, and is provided with a set of beam characteristics that enables the formation of a preliminary molten steel weld pool 80 and optionally a keyhole 82 within the weld pool 80. For example, the preliminary welding laser beam 76 may have a power level that ranges between 0.2 kW and 50 kW, or more narrowly between 1 kW and 10 kW, and a focal point 84 of the preliminary welding laser beam 76 may be located fixedly or variably somewhere between 30 mm above the top surface 20 (+30 mm) of the workpiece stack-up 10 and 30 mm below (−30 mm) the top surface 20 along a longitudinal beam axis 86. The preliminary welding laser beam 76 may be fixedly trained at the initial spot location 78 or it may be moved relative to a plane of the top surface 20 at the initial spot location 78 until the preliminary molten steel weld pool 80 grows to the desired size.

The preliminary molten steel weld pool 80 (and the keyhole 82 if present) may be grown to any of a variety of sizes. As shown in FIG. 3, for example, the preliminary molten steel weld pool 80 may fully penetrate the workpiece stack-up 10, in which case the weld pool 80 extends entirely between the top and bottom surfaces 20, 22 of the stack-up 10 and fully traverses the thicknesses 120, 140 of each of the first and second steel workpieces 12, 14. In other alternative embodiments not explicitly shown here, the preliminary molten steel weld pool 80 partially penetrates the workpiece stack-up 10, in which case the weld pool 80 extends into the stack-up 10 from the top surface 20 but does not reach the bottom surface 22. In one such implementation, the preliminary molten steel weld pool 80 only partially traverses the thickness 120 of the first steel workpiece 12, and thus does not extend through the faying interface 34 and into the second steel workpiece 14. In another implementation, the preliminary molten steel weld pool 80 fully traverse the thickness 120 of the first steel workpiece 12 and intersects the faying interface 34 of first and second steel workpieces 12, 14, but only partially traverses the thickness 140 of the second steel workpiece 14.

Once the preliminary molten steel weld pool 80 (and the keyhole 82 if present) has reached the appropriate size, the transmission of the preliminary welding laser beam 76 is ceased at the initial spot location 78. Ceasing transmission of the preliminary welding laser beam 76 at the initial spot location 78 may involve halting the transmission of the laser beam 76 from the scanning optic laser head 54 or simply moving laser beam 76 outside of the initial spot location 78 relative to the top surface 20 of the workpiece stack-up 10. By ceasing transmission of the preliminary welding laser beam, the keyhole 82 (if present) collapses and preliminary molten steel weld pool 80 solidifies into the preliminary weld deposit 74, as illustrated in FIG. 4. The preliminary weld deposit 74, which penetrates the workpiece stack-up 10 to the same extent as the preliminary molten steel weld pool 80, is comprised of resolidified composite steel workpiece material derived from each of the steel workpieces penetrated by the preliminary molten steel weld pool 80. The preliminary weld deposit 74 may, accordingly, include resolidified steel workpiece material from the first steel workpiece 12 or both the first and second steel workpieces 12, 14. The preliminary weld deposit 74 has a diameter at the top surface 20 of the workpiece stack-up 10 that preferably ranges from 2 mm to 4 mm, although smaller and larger diameters may be attained.

The at least one preliminary weld deposit 74 may include a plurality of deposits 74 formed in a similar fashion. In particular, a second preliminary welding laser beam 76 may be directed at a second spot location 78 within the weld site away from the previously-formed preliminary weld deposit 74. The second preliminary welding laser beam 76 is operable to form a second preliminary molten steel weld pool 80 (with an optional keyhole 82) that solidifies into a second preliminary weld deposit 74 following cessation of the laser beam 76 at the second spot location 78. This same process may be repeated to form any number of preliminary weld deposits 74. In fact, in a preferred embodiment, anywhere from one to eight preliminary weld deposits 74 may be formed in close proximity within the workpiece stack-up 10. Moreover, the grouped preliminary weld deposits 74 may be the same or different in terms of their penetration depth and size. To be sure, in one embodiment, all of the plurality of preliminary weld deposits 74 may fully penetrate the workpiece stack-up 10 and have a diameter between 2 mm and 4 mm at the top surface 20. In other embodiments, however, only some of the preliminary weld deposits 74 may fully penetrate the workpiece stack-up 10 while others may only partially penetrate the stack-up 10.

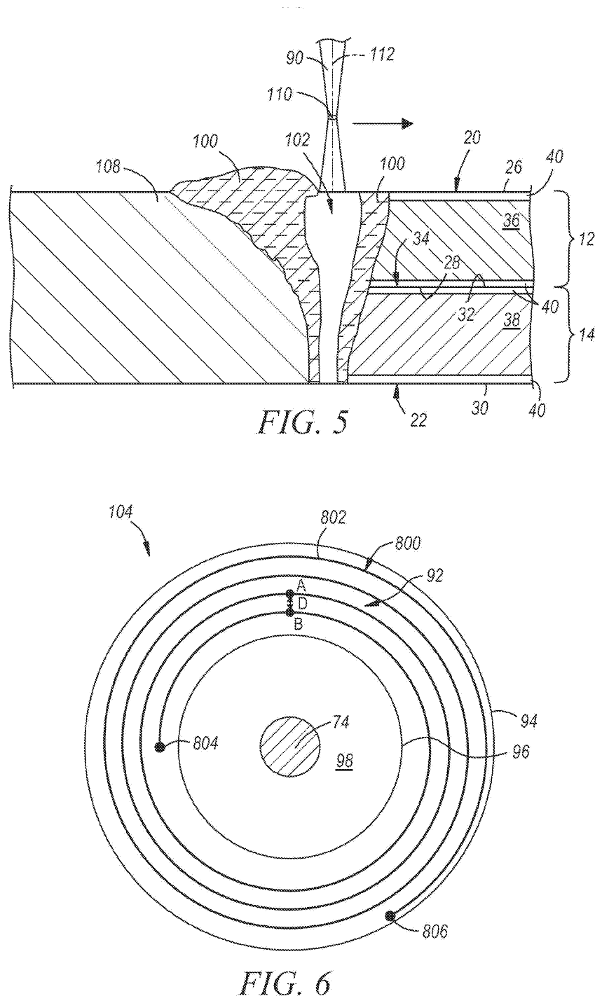

After the at least one preliminary weld deposit 74 is formed, the remote laser welding apparatus 18 forms a principal laser weld joint 88 that fusion welds the steel workpieces 12, 14 together at the weld site 16, as shown in FIGS. 2 and 5. This involves configuring the laser beam 24 of the remote laser welding apparatus 18 to operate as a principal laser welding beam 90 instead of the preliminary welding laser beam(s) 76. The principal welding laser beam 90 is directed at, and impinges, the top surface 20 of the workpiece stack-up 10 radially outside of and away from the spot location(s) 78 previously acted on by the preliminary welding laser beam(s) 76. The principal welding laser beam 90, more specifically, is directed at the top surface 20 within an annular weld area 92 as projected onto the plane (the x-y plane) of the top surface 20. The annular weld area 90 is defined by an outer diameter boundary 94 and an inner diameter boundary 96 on the plane of the top surface 20 and surrounds a center area 98 that spans the at least one preliminary weld deposit 74. The outer diameter boundary 94 preferably ranges in diameter from 5 mm to 15 mm while the inner diameter boundary 96 preferably ranges in diameter from 3 mm to 12 mm. The center area 98 is said to “span” the preliminary weld deposit(s) 74 when an imaginary extension of the center area 98 from the top surface 20 to the bottom surface 22 of the workpiece stack-up 10 delineates a volume within the stack-up 10 that encompasses the previously-formed weld deposit(s) 74.

The heat generated from absorption of the focused energy of the principal welding laser beam 90 initiates melting of the first and second metal workpieces 12, 14 to create a principal molten steel weld pool 100 that penetrates into the workpiece stack-up 10 from the top surface 20 towards the bottom surface 22. The principal molten steel weld pool 100 penetrates far enough into the workpiece stack-up 10 that it intersects the faying interface 34 established within the workpiece stack-up 10 between the first and second steel workpieces 12, 14. The principal welding laser beam 90, moreover, preferably has a power density sufficient to vaporize the workpiece stack-up 10 directly beneath where it impinges the top surface 20 of the stack-up 10. This vaporizing action produces a keyhole 102, which is a column of vaporized workpiece steel that may contain plasma. The keyhole 102 is formed within the principal molten steel weld pool 100 and also penetrates into the workpiece stack-up 10 from the top surface 20 towards the bottom surface 22 and intersects the faying interface 34 within the workpiece stack-up 10. The keyhole 102 and the surrounding principal molten steel weld pool 100 may fully (as shown) or partially penetrate the workpiece stack-up 10.

After the principal molten steel weld pool 100 and the keyhole 102 are created, the principal welding laser beam 90 is advanced relative to the plane of the top surface 20 of the workpiece stack-up along a beam travel pattern 104 (FIGS. 6-9) confined to the annular weld area 92. Advancement of the principal welding laser beam 90 along the beam travel pattern 104 is managed by precisely controlling the coordinated movements of the tiltable scanning mirrors 68 of the scanning optic laser head 54. Such coordinated movements of the scanning mirrors 68 can rapidly move the principal welding laser beam 90 to trace a wide variety of beam travel patterns of simple or complex shape as projected onto the plane of the top surface 20 of the workpiece stack-up 10. Some examples of suitable beam travel patterns 104 that may be traced by the principal welding laser beam 90 are shown in FIGS. 6-9 and described below. In general, however, and using FIGS. 6-9 as examples, the beam travel pattern 104 includes one or more nonlinear weld paths 106. What is more, the principal welding laser beam 90 is preferably advanced along the designated beam travel pattern 104 at a relatively high travel velocity that ranges between 2 m/min and 120 m/min or, more narrowly, between 8 m/min and 50 m/min.

As noted above, the beam travel pattern 104 is traced by the principal welding laser beam 90 with respect to the plane oriented along the top surface 20 of the workpiece stack-up 10 inside the annular weld area 92 and around the center area 98 that spans the at least one preliminary weld deposit 74. As such, the illustrations presented in FIGS. 6-9 are plan views, from above, of various exemplary beam travel patterns projected onto the top surface 20 of the workpiece stack-up 10. These views provide a visual understanding of how the principal welding laser beam 90 is advanced relative to the top surface 20 of the workpiece stack-up 10 during formation of the principal laser weld joint 88. The one or more nonlinear weld paths 106 within the beam travel pattern 104 may comprise a single weld path or a plurality of weld paths that include some curvature or deviation from linearity. Such weld paths may be continuously curved or they may be comprised of multiple straight line segments that are connected end-to-end at an angle to one another (i.e., the angle between the connected line segments≠180°).

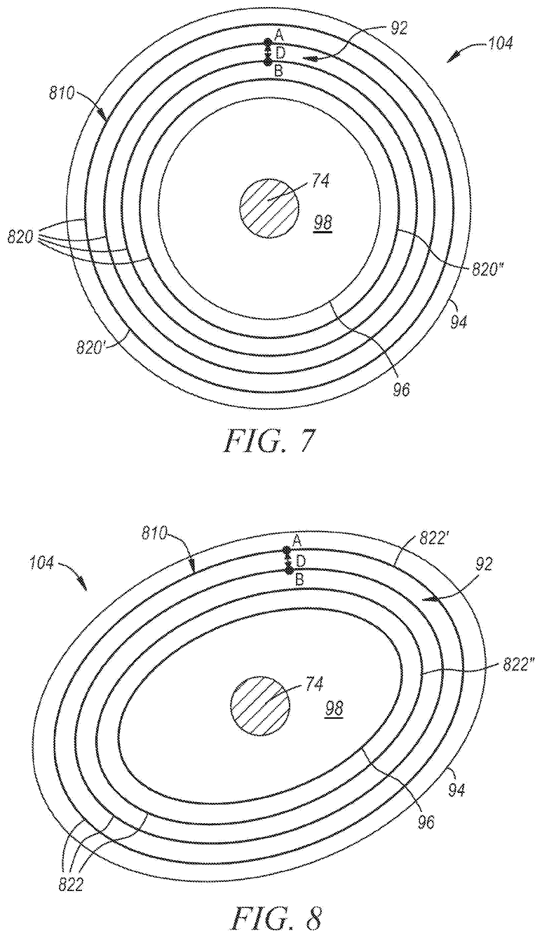

Referring now to FIGS. 6-9, the beam travel pattern 104 may comprise a spiral beam travel pattern, a closed-curve beam travel pattern, or some other beam travel pattern. A spiral beam travel pattern may be any pattern having a single weld path that revolves around the inner diameter boundary 96 of the annular weld area 92 and includes multiple turnings that are radially spaced apart between the outer and inner diameter boundaries 94, 96 with a preferred number of spiral turnings ranging from two to twenty. A closed-curve beam travel pattern may be any pattern that includes a plurality of radially-spaced and unconnected circular weld paths, elliptical weld paths, or weld paths having like closed curves. A wide variety of other patterns can also be employed as the beam travel pattern 104 including, for example, the roulette beam travel pattern shown in FIG. 9 that includes an epitrochoidal weld path. Variations of these specifically illustrated beam travel patterns 104 as well as other patterns that include nonlinear weld paths may also be traced by the principal welding laser beam 90 to form the principal laser weld joint 88.

FIG. 6 illustrates an embodiment of the beam travel pattern 104 that comprises a single nonlinear inner weld path 802 that lies within the annular weld area 92 in the form of a spiral beam travel pattern 800. Here, as shown, the spiral beam travel pattern 800 encircles the center area 98 while revolving around the inner diameter boundary 96 of the annular weld area 92 between a fixed inner point 804 and a fixed outer point 806. The single nonlinear weld path 802 of the spiral beam travel pattern 800 thus revolves around and expands radially outwardly from the fixed inner point 804 to the fixed outer point 806. The single nonlinear weld path 802 may be continuously curved, as shown in FIG. 6, and the spiral beam travel pattern 800 may further be an Archimedean spiral in which the turnings of the weld path 802 are spaced equidistantly from each other by a distance D. This distance D may be referred to as a step size and it may range between 0.01 mm and 0.8 mm as measured between radially-aligned points A, B on each pair of adjacent turnings. Alternatively, as another example, the single nonlinear weld path 802 may be arranged into an equiangular spiral beam travel pattern in which adjacent turnings of the spiral get progressively farther apart. One example of an equiangular spiral beam travel pattern is defined by the equation r(θ)=e^{-0.1(θ)} in which theta is defined in polar coordinates.

FIGS. 7-8 illustrate several embodiments of the beam travel pattern 104 that comprise a plurality of nonlinear weld paths that are distinct from each other in that none of the nonlinear weld paths intersect. Each of the beam travel patterns 104 shown in FIGS. 7-8, for example, comprises a plurality of radially-spaced and unconnected circular weld paths 820 (FIG. 7) or unconnected elliptical weld paths 822 (FIG. 8) in the form of a closed-curve beam travel pattern 810. The circular weld paths 820 and the elliptical weld paths 822 are radially spaced apart on the top surface 20 of the workpiece stack-up 10 and are concentrically arranged about the center area 98. These discrete weld paths 820, 822 may be radially spaced evenly apart (FIGS. 7-8) or they may be spaced apart at varying distances between the outer and inner diameter boundaries 94, 96. In that regard, the circular weld paths 820 include an outermost circular weld path 820 located proximate the outer diameter boundary 94 of the annular weld area 92 and an innermost circular weld path 820 located proximate the inner diameter boundary 96. The elliptical weld paths 822 include similarly located outermost and innermost elliptical weld paths 822, 822. The embodiments of the beam travel pattern 810 illustrated in FIGS. 7-8 preferably include anywhere from two to twenty weld paths 820, 822 or, more narrowly, anywhere from three to eight weld paths 820, 822. And, like the spiral beam travel pattern 800 of FIG. 6, the distance D between radially-aligned points A, B on adjacent circular or elliptical weld paths 820, 822 (or step size) preferably ranges from 0.01 mm to 0.8 mm.

Other embodiments of the beam travel pattern 104 are indeed contemplated in addition to those shown in FIGS. 6-8. In one such embodiment, which is depicted in FIG. 9, the beam travel pattern 104 is roulette beam travel pattern that includes an epitrochoidal weld path 824. The epitrochoidal weld path 824 can be represented by a path traced by a point P attached to the origin O of a rotating circle 826 of radius R rolling around the outside of a fixed circle 828. As the rotating circle 826 rotates in a clockwise direction about the fixed circle 828 such that the circumference of the rotating circle 826 meets the circumference of the fixed circle 828, the point P moves along with the circle 826 creating the epitrochoidal weld path 824 depicted in FIG. 9. The rotating circle 826 can rotate along the fixed circle 828 so that it moves point P continuously around the center area 98 within the annular weld area 92. Different epitrochoidal weld paths having shapes other than the one shown in FIG. 9 can be created by altering the distance between point P and the origin O of the rotating circle 826, by changing the radius R of the rotating circle 826, and/or by changing the diameter of the fixed circle 828.

The principal welding laser beam 90 may be advanced along the beam travel pattern 104 within the annular weld area 92 in a variety of ways. For example, with respect to the spiral beam travel pattern 800 shown in FIG. 6, the principal welding laser beam 90 may be advanced from the fixed outer point 806 nearest the outer diameter boundary 94 and around the several turnings of the single nonlinear weld path 802 until it eventually stops at the fixed inner point 804 nearest the inner diameter boundary 96. As another example, with respect to the closed-curved beam travel patterns 810 shown in FIGS. 7-8, the principal welding laser beam 90 may be advanced in a radially inward direction from the outermost weld path 820, 822 nearest the outer diameter boundary 94 to the innermost weld path 820, 822 nearest the inner diameter boundary 96. The advancement of the principal welding laser beam 90 in a radially inward direction within the annular weld area 92—particularly when the beam travel pattern includes a spiral beam travel pattern or a closed-curved beam travel pattern—is generally preferred since the patterned inward movement of the principal welding laser beam 90 along the beam travel pattern 104 helps drive any zinc vapors created by the heat of the principal welding laser beam 90 inwards towards the center of the principal laser weld joint 88.

As the principal welding laser beam 90 is being advanced along the beam travel pattern 104, which is depicted best in FIGS. 2 and 5, the keyhole 102 and the principal molten steel weld pool 100 are translated at the same speed along a corresponding route within the workpiece stack-up 10 since they track the movement of the laser beam 90. In this way, the principal molten steel weld pool 100 momentarily leaves behind a trail of molten steel workpiece material in the wake of the travel path of the principal welding laser beam 90 and the corresponding route of the keyhole 102 and the weld pool 100. This trail of molten steel workpiece material solidifies into resolidified composite steel workpiece material 108 (FIGS. 2 and 5) that is comprised of material derived from each of the steel workpieces 12, 14 penetrated by the principal molten steel weld pool 100. Eventually, when the principal welding laser beam 90 is finished tracing the beam travel pattern 104, the transmission of the principal welding laser beam 90 is ceased so that the beam 90 no longer transfers energy to the workpiece stack-up 10. At this time, the keyhole 102 collapses and the preliminary molten steel weld pool 100 solidifies. The collective resolidified composite steel workpiece material 108 obtained from advancing the principal welding laser beam 90 along the beam travel pattern 104 constitutes the principal laser weld joint 88. The resolidified composite steel workpiece material 108 may or may not consume the at least one preliminary weld deposit 74.

The depth of penetration of the keyhole 102 and the surrounding principal molten steel weld pool 100 is controlled during advancement of the principal welding laser beam 90 along the beam travel pattern 104 to ensure the steel workpieces 12, 14 are fusion welded together by the principal laser weld joint 88 at the weld site 16. In particular, as mentioned above, the keyhole 102 and the principal molten steel weld pool 100 intersect the faying interface 34 established between the first and second steel workpieces 12, 14 within the workpiece stack-up 10. In fact, in a preferred embodiment, as shown best in FIG. 5, the keyhole 102 and the principal molten steel weld pool 100 fully penetrate the workpiece stack-up 10, meaning that both the keyhole 102 and the principal molten steel weld pool 100 extend from the top surface 20 all the way through the stack-up 10 to the bottom surface 22. By causing the keyhole 102 and the principal molten steel weld pool 100 to penetrate far enough into the workpiece stack-up 10 that they intersect the faying interface 34—either by way of full or partial penetration—the resolidified composite steel workpiece material 108 produced by advancing the principal welding laser beam 90 along the beam travel pattern 104 serves to autogenously fusion weld the steel workpieces 12, 14 together.

The depth of penetration of the keyhole 102 and the surrounding principal molten steel weld pool 100 can be attained by controlling various characteristics of the principal welding laser beam 90 including the power level of the laser beam 90, the position of a focal point 110 of the laser beam 90 along a longitudinal axis 112 of the beam 90, and the travel velocity of the laser beam 90 when being advanced along the beam travel pattern 104. These beam characteristics can be programmed into a weld controller capable of executing instructions that dictate the penetration depth of the keyhole 102 and the surrounding principal molten steel weld pool 100 with precision. While the various characteristics of the principal welding laser beam 90 can be instantaneously varied in conjunction with one another to attain the penetration depth of the keyhole 102 and the principal molten steel weld pool 100 at any particular portion of the beam travel pattern 104, in many instances, regardless of the profile of the beam travel pattern 104, the power level of the principal welding laser beam 90 may be set to between 0.2 kW and 50 kW, or more narrowly between 1 kW and 10 kW, the travel velocity of the principal welding laser beam 90 may be set to between 2 m/min and 120 m/min or, more narrowly, between 8 m/min and 50 m/min, and the focal point 108 of the principal welding laser beam 90 may be located fixedly or variably somewhere between 30 mm above the top surface 20 (+30 mm) of the workpiece stack-up 10 and 30 mm below (−30 mm) the top surface 20.

Without being bound by theory, the formation of the at least one preliminary weld deposit 74 in the workpiece stack-up followed by the advancement of the principal welding laser beam 90 along the beam travel pattern 104 within the annular weld area 92 is believed to promote good strength—in particular good peel and cross-tension strength in the principal laser weld joint 88. Specifically, the formation of the at least one preliminary weld deposit 74 reduces the amount of vaporizable zinc within the workpiece stack-up 10 beneath the center area 98 and the annular weld area 92 by boiling off zinc or by converting zinc to high-boiling point zinc oxide. This reduction in the amount of vaporizable zinc during formation of the preliminary weld deposit(s) 74 means that less high-pressure zinc vapors will be generated and possibly become trapped in the principal molten steel weld pool 100 during advancement of the principal welding laser beam 90 along the beam travel pattern 104. As a result, the presence of entrained porosity within the resolidified composite steel workpiece material 108 of the principal laser weld joint 88 is kept to manageable levels or altogether eliminated, and the potential for of spatter and blowholes is significantly minimized.

Moreover, the advancement of the principal welding laser beam 90 along the beam travel pattern 104 within the annular weld area 92 has the effect of driving any zinc vapors that may be generated in a radially inward direction towards the interior of the principal laser weld joint 88. The consolidation and induced guidance of zinc vapors towards the interior of the principal laser weld joint 88 occurs either along the faying interface 34 if the portion of the workpiece stack-up 10 beneath the center area 98 does not melt and/or through molten steel if some or all of the portion of the stack-up 10 beneath the center area 98 does melt as a result of conductive heat transfer. By guiding zinc vapors towards the interior of the principal laser weld joint 88, the patterned movement of the principal welding laser beam 90 within the annular weld area 92 effectively sweeps a significant portion of any porosity that may be present into a region of the principal laser weld joint 88 beneath the center area 98 on the plane of the top surface 20 of the workpiece stack-up 10. The concentration of porosity beneath the center area 98 is tolerable since centrally-located porosity is less likely to affect the mechanical properties of the principal laser weld joint 88 compared to porosity located at the perimeter of the weld joint 88.

FIGS. 1 and 3-5 illustrate the above-described embodiments of the disclosed method in the context of the workpiece stack-up 10 being a “2T” stack-up that includes only the first and second steel workpieces 12, 14 with their single faying interface 34. The same laser welding method, however, may also be carried out when the workpiece stack-up 10 is a “3T” stack-up that includes an additional third steel workpiece 200, with a thickness 220, that overlaps and is situated between the first and second steel workpieces 12, 14, as depicted in FIGS. 10-12. In fact, regardless of whether the workpiece stack-up 10 is a 2T or a 3T stack-up, the laser welding method does not have to be modified all that much to form the preliminary weld deposit(s) 74 and the principal laser weld joint 88. And, in each instance, the principal laser weld joint 88 can achieve good quality strength properties despite the fact that at least one, and sometimes all, of the steel workpieces includes a surface coating 40 comprised of a zinc-based material such as zinc (e.g., hot-dip galvanized or electrogalvanized) or a zinc-iron alloy (e.g., galvanneal).

Referring now to FIGS. 10-12, the additional third steel workpiece 200, if present, includes a third base steel substrate 202 that may be optionally coated with the same surface coating 40 described above. When the workpiece stack-up 10 includes the first, second, and third overlapping steel workpieces 12, 14, 200, the base steel substrate 36, 38, 202 of at least one of the workpieces 12, 14, 200, and sometimes all of them, includes the surface coating 40. As for the characteristics (e.g., composition, thickness, etc.) of the third base steel substrate 202, the descriptions above regarding the first and second base steel substrates 36, 38 are equally applicable to that substrate 202 as well. It should be noted, though, that while the same general descriptions apply to the several steel workpieces 12, 14, 200, there is no requirement that the steel workpieces 12, 14, 200 be identical to one another. In many instances, the first, second, and third steel workpieces 12, 14, 200 are different in some aspect from each other whether it be composition, thickness, and/or form.

As a result of stacking the first, second, and third steel workpieces 12, 14, 200 in overlapping fashion to provide the workpiece stack-up 10, the third steel workpiece 200 has two faying surfaces 204, 206. One of the faying surfaces 204 overlaps and confronts the first faying surface 28 of the first steel workpiece 12 and the other faying surface 206 overlaps and confronts the second faying surface 32 of the second steel workpiece 14, thus establishing two faying interfaces 208, 210 within the workpiece stack-up 10 that extend through the weld site 16. These faying interfaces 208, 210 are the same type and encompass the same attributes as the faying interface 34 already described above with respect to FIGS. 3-5. Consequently, in this embodiment as described herein, the exterior outer surfaces 26, 30 of the flanking first and second steel workpieces 12, 14 still face away from each other in opposite directions and constitute the top and bottom surfaces 20, 22 of the workpiece stack-up 10.

The formation of the at least one preliminary weld deposit 74 and, subsequently, the principal laser weld joint 88 in the “3T” workpiece stack-up 10 are achieved in the same manner as previously described. The formation of each preliminary weld deposit 74, for example, is carried out by directing the preliminary welding laser beam 76 at a spot location 78 on the top surface 20 of the workpiece stack-up 10 within the weld site 16 to create the preliminary molten steel weld pool 80 and optional keyhole 82, as illustrated in FIG. 10. Eventually, as shown in FIG. 11, the transmission of the preliminary welding laser beam 76 is ceased at the spot location 78 to cause the preliminary molten steel weld pool to solidify into the preliminary weld deposit 74. The preliminary weld deposit 74 may partially or fully penetrate into the workpiece stack-up 10. Indeed, in one embodiment, as shown here in FIG. 10, the preliminary weld deposit 74 extends entirely between the top and bottom surfaces 20, 22 of the stack-up 10 and fully traverses the thicknesses 120, 140, 220 of each of the first, second, and third steel workpieces 12, 14, 200. The preliminary weld deposit 74 has diameter at the top surface 20 that preferably ranges from 2 mm to 4 mm, although other diameters may certainly be employed. Additionally, as before, more than one preliminary weld deposit 74 may be formed, with one to eight weld deposits 74 being typical.

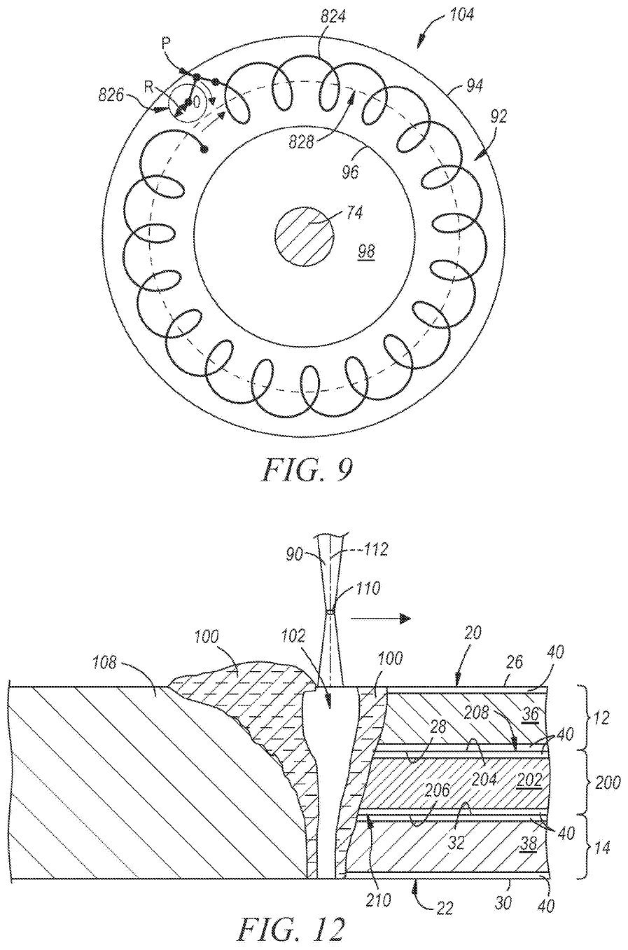

The formation of the principal laser weld joint 88 is carried out by advancing the principal welding laser beam 90 along the beam travel pattern 104 within the annular weld area 92 as discussed above. Such advancement of the principal welding laser beam 90 translates the optional keyhole 102 and the surrounding principal molten steel weld pool 100 along a corresponding route to ultimately yield the resolidified composite steel workpiece material 108 that collectively constitutes the principal laser weld joint 88 and fusion welds the three steel workpieces 12, 14, 200 together. And, like before, in a preferred embodiment, the keyhole 102 and the surrounding principal molten steel weld pool 100 fully penetrate the workpiece stack-up 10, as shown in FIG. 12, although in alternative embodiments the keyhole 102 and the weld pool 100 may only partially penetrate the stack-up 10. Any of the exemplary beam travel patterns 104 depicted in FIGS. 6-9, as well others not depicted, may be traced by the advancing principal welding laser beam 90 during formation of the principal laser weld joint 88 to achieve the same beneficial effects as previously described.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser welding a workpiece stack-up that includes at least two overlapping steel workpieces, the method comprising:
providing a workpiece stack-up that includes overlapping steel workpieces, the workpiece stack-up comprising at least a first steel workpiece and a second steel workpiece, the first steel workpiece providing a top surface of the workpiece stack-up and the second steel workpiece providing a bottom surface of the workpiece stack-up, wherein a faying interface is established between each pair of adjacent overlapping steel workpieces within the workpiece stack-up, and wherein at least one of the steel workpieces in the workpiece stack-up includes a surface coating of a zinc-based material;
directing a preliminary welding laser beam at an initial spot location on the top surface of the workpiece stack-up, the preliminary welding laser beam impinging the top surface and creating a preliminary molten steel weld pool that penetrates into the workpiece stack-up from the top surface towards the bottom surface;
ceasing transmission of the preliminary welding laser beam at the initial spot location to cause the preliminary molten steel weld pool to solidify into a preliminary weld deposit that extends partially or fully through the workpiece stack-up;
directing a principal welding laser beam at the top surface of the workpiece stack-up, the principal welding laser beam impinging the top surface radially outside of the initial spot location and away from the preliminary weld deposit to create a principal molten steel weld pool that penetrates into the workpiece stack-up from the top surface towards the bottom surface and that intersects each faying interface established within the workpiece stack-up; and
forming a principal laser weld joint by advancing the principal welding laser beam relative to a plane of the top surface of the workpiece stack-up along a beam travel pattern that lies within an annular weld area defined by an inner diameter boundary and an outer diameter boundary on the plane of the top surface, the annular weld area and the beam travel pattern of the principal welding laser beam each surrounding a center area on the plane of the top surface that spans the preliminary weld deposit formed in the workpiece stack-up.

2. The method set forth in claim 1, wherein the first steel workpiece has an exterior outer surface and a first faying surface, and the second steel workpiece has an exterior outer surface and a second faying surface, the exterior outer surface of the first steel workpiece providing the top surface of the workpiece stack-up and the exterior outer surface of the second steel workpiece providing the bottom surface of the workpiece stack-up, and wherein the first and second faying surfaces of the first and second steel workpieces overlap and confront to establish a first faying interface.

3. The method set forth in claim 1, wherein the first steel workpiece has an exterior outer surface and a first faying surface, and the second steel workpiece has an exterior outer surface and a second faying surface, the exterior outer surface of the first steel workpiece providing the top surface of the workpiece stack-up and the exterior outer surface of the second steel workpiece providing the bottom surface of the workpiece stack-up, and wherein the workpiece stack-up comprises a third steel workpiece situated between the first and second steel workpieces, the third steel workpiece having opposed faying surfaces, one of which overlaps and confronts the first faying surface of the first steel workpiece to establish a first faying interface and the other of which overlaps and confronts the second faying surface of the second steel workpiece to establish a second faying interface.

4. The method set forth in claim 1, wherein directing the preliminary welding laser beam at the initial spot location on the top surface of the workpiece stack-up comprises fixedly training the preliminary welding laser beam at the initial spot location on top surface.

5. The method set forth in claim 1, wherein directing the preliminary welding laser beam at the initial spot location on the top surface of the workpiece stack-up comprises moving the preliminary welding laser beam relative to a plane of the top surface at the initial spot location.

6. The method set forth in claim 1, wherein each of the preliminary welding laser beam and the principal welding laser beam has a power level that ranges from 1 kW to 10 kW.

7. The method set forth in claim 1, wherein the preliminary weld deposit fully penetrates the workpiece stack-up such that the weld deposit extends between the top and bottom surfaces of the workpiece stack-up.

8. The method set forth in claim 1, wherein the preliminary weld deposit has a diameter that ranges from 2 mm to 4 mm at the top surface of the workpiece stack-up.

9. The method set forth in claim 1, further comprising:
directing a second preliminary welding laser beam at a second initial spot location on the top surface of the workpiece stack-up, the second preliminary welding laser beam impinging the top surface and creating a second preliminary molten steel weld pool that penetrates into the workpiece stack-up from the top surface towards the bottom surface;
ceasing transmission of the second preliminary welding laser beam at the second initial spot location to cause the second preliminary molten steel weld pool to solidify into a second preliminary weld deposit that extends partially or fully through the workpiece stack-up, the second preliminary weld deposit being formed in the workpiece stack-up such that the center area on the plane of the top surface spans both the preliminary weld deposit and the second preliminary weld deposit.

10. The method set forth in claim 1, wherein advancing the principal welding laser beam along the beam travel pattern is performed by a scanning optic laser head having tiltable scanning mirrors whose movements are coordinated to move the principal welding laser beam relative to the plane of the top surface of the workpiece stack-up.

11. The method set forth in claim 10, wherein the principal welding laser beam is advanced along the beam travel pattern at a travel speed that ranges from 8 m/min to 50 m/min.

12. The method set forth in claim 1, wherein the beam travel pattern of the principal welding laser beam is a spiral beam travel pattern that comprises a single nonlinear weld path that revolves around and expands radially outwardly from a fixed inner point proximate the inner diameter boundary to a fixed outer point proximate the outer diameter boundary of the annular weld area.

13. The method set forth in claim 12, wherein a step size between radially-aligned points on each pair of adjacent turnings of the weld path of the spiral beam travel pattern is greater than 0.01 mm and less than 0.8 mm.

14. The method set forth in claim 12, wherein the principal welding laser beam is advanced along the spiral beam travel pattern from the fixed outer point proximate the outer diameter boundary of the annular weld area to the fixed inner point proximate the inner diameter boundary.

15. The method set forth in claim 1, wherein the beam travel pattern of the principal welding laser beam is a closed-curve beam travel pattern that comprises a plurality of radially spaced and unconnected circular or elliptical weld paths that are concentrically arranged about the center area.

16. The method set forth in claim 15, wherein a step size between radially-aligned points of each pair of adjacent circular or elliptical weld paths is greater than 0.01 mm and less than 0.8 mm.

17. The method set forth in claim 15, wherein the principal welding laser beam is advanced along the closed-curve beam travel pattern in a radially inward direction from an outermost weld path proximate the outer diameter boundary of the annular weld area to an innermost weld path proximate the inner diameter boundary.

18. The method set forth in claim 1, wherein a diameter of the inner diameter boundary of the annular weld area ranges from 3 mm to 12 mm and a diameter of the outer diameter boundary ranges from 5 mm to 15 mm.

19. A method of remote laser welding a workpiece stack-up that includes at least two overlapping steel workpieces, the method comprising:
providing a workpiece stack-up that includes overlapping steel workpieces, the workpiece stack-up comprising at least a first steel workpiece and a second steel workpiece, the first steel workpiece providing a top surface of the workpiece stack-up and the second steel workpiece providing a bottom surface of the workpiece stack-up, wherein a faying interface is established between each pair of adjacent overlapping steel workpieces within the workpiece stack-up, and wherein at least one of the steel workpieces in the workpiece stack-up includes a surface coating of zinc or a zinc-iron alloy;
operating a scanning optic laser head to form at least one preliminary weld deposit that extends from the top surface of the workpiece stack-up either partially or fully through the workpiece stack-up, each of the at least one preliminary weld deposits being formed by directing a solid-state preliminary welding laser beam at an initial spot location on the top surface of the workpiece stack-up to create a preliminary molten steel weld pool that penetrates into the workpiece stack-up from the top surface towards the bottom surface, followed by ceasing transmission of the preliminary welding laser beam at the initial spot location to cause the preliminary molten steel weld pool to solidify;
operating the scanning optic laser head to direct a principal welding laser beam at the top surface of the workpiece stack-up after formation of the at least one preliminary weld deposit, the principal welding laser beam impinging the top surface within an annular weld area defined by an inner diameter boundary and an outer diameter boundary on the plane of the top surface to create a principal molten steel weld pool that penetrates into the workpiece stack-up from the top surface towards the bottom surface, the annular weld area surrounding a center area on the plane of the top surface that spans the at least one preliminary weld deposit formed in the workpiece stack-up; and
coordinating the movement of tiltable scanning mirrors within the scanning optic laser head to advance the principal welding laser beam relative to the plane of the top surface of the workpiece stack-up and along a beam travel pattern that lies within the annular weld area and surrounds the center area that spans the at least one preliminary weld deposit, and wherein the principal welding laser beam is advanced along the beam travel pattern at a travel speed that ranges from 2 m/min to 120 m/min.

20. The method set forth in claim 19, wherein the at least one preliminary weld deposit is a single preliminary weld deposit having a diameter that ranges from 2 mm to 4 mm at the top surface of the workpiece stack-up, and wherein a diameter of the inner diameter boundary of the annular weld area ranges from 3 mm to 12 mm and a diameter of the outer diameter boundary ranges from 5 mm to 15 mm.
